(19) United States
(12) Patent Application Publication
(10) Pub. No.: US 2011/0313331 A1
(43) Pub. Date: Dec. 22, 2011

(54) Rehabilitation Robot

(76) Inventors: Bruno Marc Florent Victore Dehez, Liernu (BE); Julien Marielle Daniel Sapin, Beauvechain (BE); Pierre Didier, Fauvillers (BE); Arnaud Attanasi, Trazegnies (BE)

(21) Appl. No.: 13/148,546

(22) PCT Filed: Feb. 10, 2010
(86) PCT No.: PCT/EP2010/051660

§ 371 Date: Aug. 9, 2011

(30) Foreign Application Priority Data
Feb. 10, 2009 (BE) 2009/0073

(51) Int. Cl. A61H 1/02; B23P 11/00

(52) U.S. Cl. 601/33; 29/428

(57) ABSTRACT

The invention relates to a device for mobilizing and rehabilitating an upper limb of a patient and a method of assembling such a device, It may be made up by assembling at least two adjacent elements chosen from a set comprising a shoulder module (105) (ShouldeRO), an arm module (205) (ROThum), an elbow module (305) (elBOT), a forearm module (405) (ROTuln), a wrist module (505) (wristlC), a dorsal holding device (107), an elbow shell CC and a hand shell (514). Each of the elements (105; 205; 305; 405; 505; 107: CC; 514) of the set is designed to be secured to at least one other adjacent element (105; 205; 305; 405; 505; 107; CC; 514) of the set, at least one assembly of a first element with a second element being achievable by engaging a male piece (600) secured to the first element in a female piece (610) secured to the second element in a direction of engagement which is not subjected to any load when the device is in operation, and by locking said male piece (600) in said female piece (610) using means that can be unlocked under the effect of a pull in a direction opposite to said direction of engagement

### TECHNICAL FIELD

The invention relates to the field of mobilization and rehabilitation robots. More specifically, the invention relates to a device for mobilizing and rehabilitating an upper limb of a patient, and to a method for assembling such a device.

### DESCRIPTION OF THE PRIOR ART

Among the motor problems caused by hemiplegia, the loss of mobility of the upper limbs is just as troublesome as that of the lower limbs. Just think how many day-to-day actions involve both arms (getting dressed, eating, pursuing various leisure pursuits, etc). Recovery of these motor skills, which is conventionally performed by a therapist, can be hastened by the use of a robotized system as various clinical studies have already shown. However, in addition to the “robotic” performances of a given device (by which we mean: workspace, mobility, type of part, etc), there are other “higher level” criteria that need to be taken into consideration when producing such a device. These are connected with the clinical aspects of course, but also relate to things of a more practical nature, and even with making the patient's rehabilitation more play like.

Systems in which only the patient's hand is controlled directly, the arm and forearm being guided only indirectly, are known. One example of such a device is described in U.S. Pat. No. 5,446,213 which provides the patient's hand with movement in two degrees of freedom. Forces and movements are transferred through a handgrip mounted on the robot and which the patient grasps. This device is designed so that, where having low inertia and very little friction, it exhibits reversible behavior at its distal part. Force and position sensors are used to inform the regulators. A module with three degrees of freedom can be mounted on the end of the flat device, thus providing the wrist with three active degrees of freedom in addition. Visual instructions regarding the movement are given via a computer screen. However, because the device mobilizes only the patient's hand, no control over the position of the arm is provided during the exercises. This results in a high risk of damage to joints,

Unlike the external robots discussed in the previous paragraph, there are also known exoskeletons which allow each of the joints of a patient's limb to be mobilized specifically. In these devices, it is important for the axes of rotation of the robot to be aligned with the biomechanical axes of the patient. FIG. 1 depicts such an exoskeleton in which the three joint rotations and the two segmental rotations are performed: movement of the shoulder complex 100, humeral rotation 200, movement of the elbow complex 300, ulnar rotation 400 and movement of the wrist complex 500.

WO 2006/058442 discloses a “system and method for a cooperative arm therapy and corresponding rotation module”. Unlike the device described in U.S. Pat. No. 5,446,213, this system comprises an exoskeleton, that is to say an external skeleton which accompanies each of the segments of a patient's limb. An exoskeleton allows each joint to be mobilized in a defined and controlled way. In such an exoskeleton, the axes of rotation of the exoskeleton and the corresponding physiological axes of rotation of the patient have to be exactly superposed because if they are not, there is a risk that the robot will exert undue force on the patients joints. Starting out with a fixed framework, a succession actuators and of shells or cuffs fitting round a portion of a patients limb mobilize each of the patients joints. The object of this document WO 2006/058442 is to provide an appliance in which a greater number of degrees of freedom can be exploited and maintained than in earlier systems. The device described has 5 motorized degrees of freedom: it allows the flexing/extending of the elbow and the movements of the shoulder with three degrees of freedom in rotation. This device does, however, have numerous disadvantages: in this device, the humeral and ulnar rotations are performed by means of concentric external and internal half-cylinders rotating relative to one another (these being 16 and 17 for humeral rotation and 20 and 21 for ulnar rotation, respectively) acting by means of linkages (18 and 19) on an elbow shell. These mechanisms are heavy and complicated. In addition, they do not guarantee that the mechanic axis of rotation defined by the axis of the two cylinders will coincide with the physiological axis of rotation of the patient. When this device is in use, the patient has to be positioned in a predefined position relative to the frame 2 of the appliance, with the patient's shoulder or, more specifically, the point of rotation of its humeral joint, under the first driver 25. The patient is not free to choose whether he is in a seated, standing or lying-down position. Finally, this device does not allow movements of the wrist. In addition, it is complicated, heavy and difficult to use.

EP2070492 discloses a “motion assisting device and motion assisting device maintenance/management system”. FIG. 1 of that document depicts by way of example a device for rehabilitating the right arm of a patient. That device comprises a “shoulder” part (reference 5 in FIG. 1 of that document), an “arm” part (reference 3), an “elbow part” (reference 6) and a “forearm” part (reference 4). However, there is nothing provided in this device to allow all or part of the upper limb, for example the shoulder, the elbow or the wrist, to be rehabilitated. Indeed this device is designed as an individual device. Although in theory it is possible to dismantle the parts of this device (see, for example, FIG. 2 and paragraph 26 of that document), such dismantling is not easy. In addition, there is nothing provided for terminating a selected part or group of parts or connecting them with the limb.

In the special case of hemiplegia, the rate at which the motor skills in the upper limb are recovered varies from the proximal to the distal end.

This is because the proximal joints recover more quickly than the distal joints. It would therefore be beneficial to be able first of all to rehabilitate the limb in its entirety in a first stage of rehabilitation. At a later stage, it may be advantageous to target work on only those joints that still require a robotized aid, for example the forearm and finally the wrist when the patient has already recovered sufficient motor skills in his shoulder and elbow. There is therefore a need for a appliance that allows a selected number of joints of a patient's limb to be mobilized. For other pathologies, such as elbow damage, a device mobilizing just a single movement may prove necessary. There is therefore a need for a rehabilitation device which leaves the therapist the freedom to choose which joints require robotized assistance, and to do so according to the progress that the patient is making in his rehabilitation and according to the type of exercise to be performed. However, creating a device that exhibits these features runs into various difficulties. First of all, there is the problem of weight: whereas in the known exoskeletons like the one described in WO 2006/058442, the weight of the structure can be transferred from the distal part to the proximal part and to the fixed frame that supports it through the structure itself and its actuators, the same is not true if there is a desire to be able to select which joints are to be mobilized, for example only the distal joints.

This is because it may be desirable to be able to fit the patient with a device that mobilizes a particular joint, for example a distal joint, without this device being connected to a fixed frame via a structure that supports its weight. Specifically, in the absence of proximal components that are able to take up the weight of the distal components, the latter need to be supported by the patient himself. Next, there is the problem of interconnectability: in order to be able to provide the patient with robotized assistance for absolutely any combination of his joints, the possibility of interconnecting and of combining the various components of the device becomes a matter of critical importance from an ergonomic standpoint, the standpoint of ease of use, and the standpoint of weight or of reacting the various forces of reaction,

There is therefore a need for a mobilization and rehabilitation device that can be readily adapted to suit the patient's build and which makes it possible to select which parts (shoulder, elbow, wrist) of the upper limb are to be mobilized.

### SUMMARY OF THE INVENTION

In a first aspect, the invention relates to a device for mobilizing and rehabilitating an upper limb of a patient, which may be made up by assembling at least two adjacent elements chosen from a set comprising a shoulder module (ShouldeRO), an arm module (ROThum), an elbow module (elBOT), a forearm module (ROTuln), a wrist module (wristlC), a dorsal holding device, an elbow shell CC and a hand shell, each of the elements of the set being designed to be secured to at least one other adjacent element of the set, at least one assembly of a first element with a second element being achievable by engaging a male piece secured to the first element into an opening in a female piece secured to the second element in a direction of engagement which is not subjected to any load when the device is in operation, and by locking said male piece in said female piece using means that can be unlocked under the effect of a pull in a direction opposite to said direction of engagement.

In a first alternative form of the unlockable means, the male piece comprises a notch and the female piece is provided with a spring clip so that upon assembly, the spring clip engages in the notch, the male piece thus being held in position but being able to be released by said pull.

In a second alternative form of the unlockable means, the male piece comprises a milled groove and the opening is provided with a spring-loaded push-button, so that upon assembly, the ball of the spring-loaded push-button engages in the milled groove, the male piece thus being held in position but being able to be released by said pull.

In a third alternative form of the unlockable means the male piece comprises at its end a ferromagnetic material and the closed end of the opening is provided with a magnet so that the male piece is thus held in place but can be released by said pull.

In a second aspect, the invention relates to a device for mobilizing and rehabilitating a patient's upper limb which comprises at least one module chosen from the abovementioned set. Each of these modules is designed to be secured to a portion of the patients upper limb and/or to at least one other module of the set.

The shoulder module may comprise a multi-jointed structure comprising a succession of rings arranged parallel to one another along an axis and articulated to one another by hinges.

This multi-jointed structure may comprise mechanical cables running through sheaths, a pair of cables controlling the rotation of a ring with respect to the ring that precedes it in the succession of rings

The arm module (ROThum) may comprise a flexible shaft, the proximal end of the shaft being made to rotate and allowing the rotation to be imparted to the distal end of said shaft.

For preference, a slideway is arranged at one of the ends of the flexible shaft so that the length of the arm module can be adapted to suit the position and build of a patient,

The elbow module (elBOT) may comprise a pivot connection comprising an upper part and a lower part, the lower part comprising a slideway supporting a shell that can be fixed to the proximal part of the forearm of a patient.

The forearm module (ROTuln) may comprise a flexible shaft, the proximal end of the flexible shaft being made to rotate and allowing the rotation to be imparted to the distal end of said shaft.

For preference, a slideway is arranged at one of the ends of the flexible shaft so that the length of the forearm module can be adapted to suit the position and build of a patient.

The wrist module (wristlC) may comprise a pivot connection comprising an upper part and a lower part, the lower part comprising a slideway supporting a hand shell that can be fixed to the hand of a patient.

in a third aspect, the invention relates to a method of assembling a device for mobilizing and rehabilitating an upper limb of a patient, which comprises at least two elements chosen from the set comprising a shoulder module (ShouldeRO), a humeral rotation module (ROThum), an elbow module (elBOT), a forearm module (ROTuln) and a wrist module (wristlC). Each of the elements of the set is designed to be secured to at least one other adjacent element of the set, at least one assembly of a first element with a second element being achievable by engaging a male piece secured to the first element into an opening in a female piece secured to the second element in a direction of engagement which is not subjected to any load when the device is in operation, and by locking said male piece into an opening in said female piece using means that can be unlocked under the effect of a pull in a direction opposite to said direction of engagement. The set may also comprise a dorsal holding device, an elbow shell CC and a hand shell.

For preference, the assembly uses one of the three aforementioned alternative forms of unlockable means.

### BRIEF DESCRIPTION OF THE DRAWINGS

FIG. 1 schematically depicts the 3 joint rotations or the 2 segmental rotations in a device for mobilizing and rehabilitating a patient's upper limb.

FIG. 2 is an overall view of a shoulder module of a mobilizing and rehabilitation device according to the invention.

FIGS. 3a, 3b, 3c are respectively a base, a mover and a general arrangement of the multi-jointed structure of a shoulder module of a device according to the invention. FIG. 3d depicts a mode of action of the cables that act on a mover.

FIGS. 4 and 5 are respectively a side view of the mode of operation of the cables acting on a mover and a perspective view of part of a control device acting on the set of cables.

FIG. 6a depicts an arm module.

FIG. 6b is a view of a dorsal holding device.

FIG. 7 depicts an elbow module.

FIG. 8 depicts a forearm module.

FIGS. 9a and 9b depict a wrist module.

FIGS. 10a, 10b, 10c and 10d schematically depict various possible ways of arranging several modules.

FIGS. 11a, 11b and 11c depict a first way of assembling several modules with one another using a spring clip.

FIGS. 11d and lie depict a second way of assembling several modules with one another by means of a spring-loaded push-button.

FIGS. 11f and 11g depict a third way of assembling several modules with one another using a permanent magnet.

FIG. 12 depicts one way of arranging the arm module and the forearm module with the elbow module.

FIG. 13 depicts one way of arranging the forearm module with the wrist module.

FIGS. 14a and 14b respectively depict a view from the front and a view from the rear of the assembly of an arm module on a dorsal module.

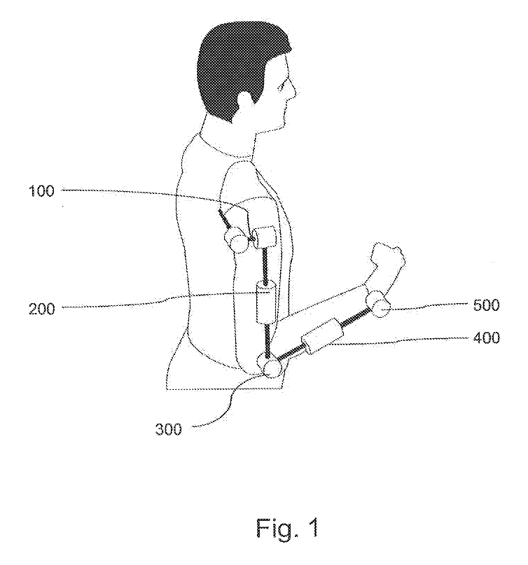

### DETAILED DESCRIPTION OF ONE EMBODIMENT OF THE INVENTION

The mobilization and rehabilitation device of the invention has the overall form of an exoskeleton in as much as it is positioned along the patient's arm, in parallel with its anatomical structure. Unlike conventional exoskeletons, the structure of which deploys in one piece from the torso as far as the patient's hand, the device of the invention is made up of an assembly created from a set comprising five independent modules and three attachment accessories. The five modules take care of the movements of the three joint complexes that are the shoulder complex, the elbow complex and the wrist complex, and of the two segmental rotations that are the ulnar rotation and the humeral rotation. The three attachment accessories are a dorsal holding device, an elbow shell, and a hand shell. The shells can be created by molding, for example in reinforced polymer. A range of shells of various sizes may be produced, or shells may be custom fitted to a patient. Each of the five modules can be used in isolation or in conjunction with one or more other modules. Each of the five modules will be described first of all here, as they can be used in isolation. The means of using the modules together will then be described. Finally, the various ways of assembling modules with one another or with an attachment accessory, which allow easy assembly/dismantling of a mobilization device customized to suit a given patient and a given application, will then finally be described.

### The Modules Used in Isolation

Each of the modules described hereinbelow can be used in isolation.

### The Shoulder Module: ShouldeRO

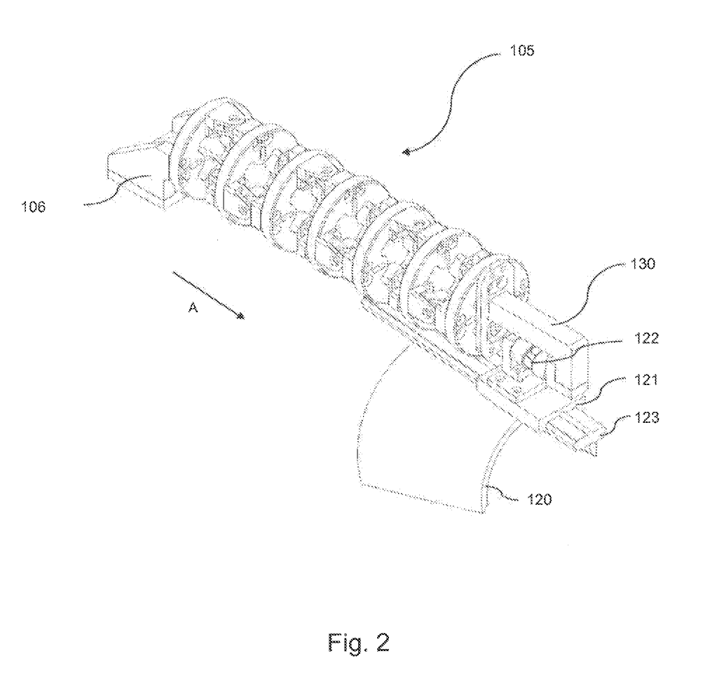

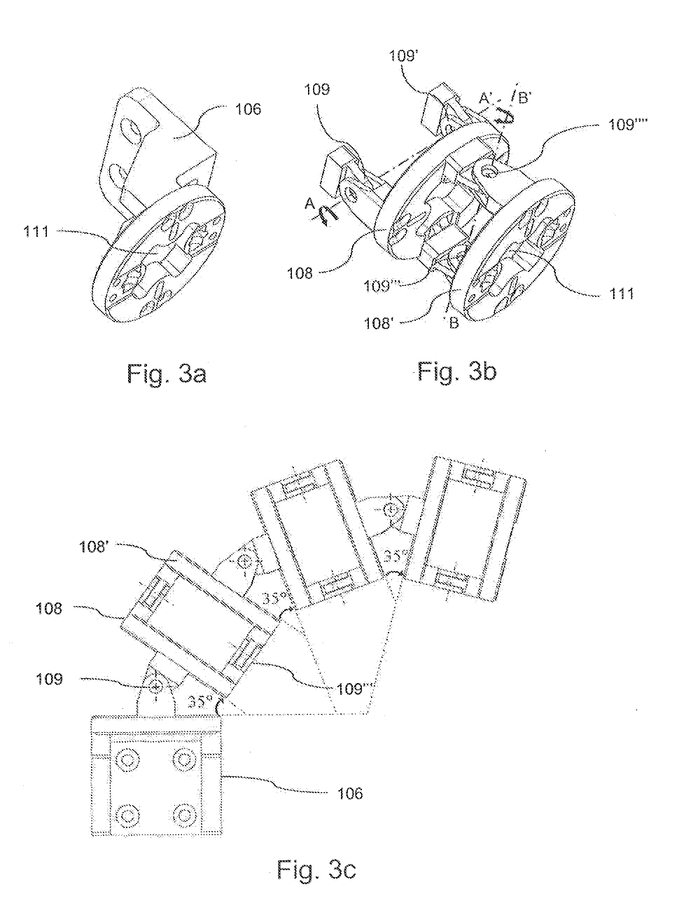

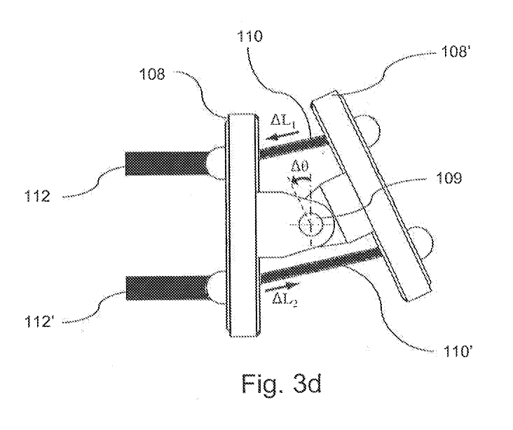

The module allowing antepulsion, retropulsion, abduction and adduction of the arm, hereinafter known as the “shoulder module” (ShouldeRO) 105 depicted in FIG. 2 is a multi-jointed structure which manages the two degrees of freedom of the shoulder complex. The mechanical structure of this module 105 comprises a base 106 anchored to the patient's torso, near his shoulder blade. This anchorage can be achieved by means of a dorsal holding device 107 described hereinafter, The base 106 is depicted in FIG. 3a, It may be fixed to the dorsal holding device 107 by bolting. A succession of identical movers, an individual example of which is depicted in FIG. 3b, are each made up of two rings 108 and 108′, Two hinges 109 and 109′ articulate the ring 108 in rotation about an axis A-A′ and two hinges 109″ and 109′″ articulate the ring 108′ with respect to the ring 108 in rotation about an axis B-B′ perpendicular to the axis A-A′. As each of the pairs of hinges provides a degree of freedom of around 35°, it has been determined that a device as illustrated in FIG. 3c and comprising 3 successive movers, namely six pairs of hinges, would make it possible to obtain the desired amplitude of movement. Mechanical cables 110 running in sheaths 112, 112′ pass through openings 111 made in the rings. The movement between two rings 108, 108′ depicted in FIG. 3d is created by pulling on one of these cables 110, movement in the opposite direction being obtained by pulling on the other cable 110′.

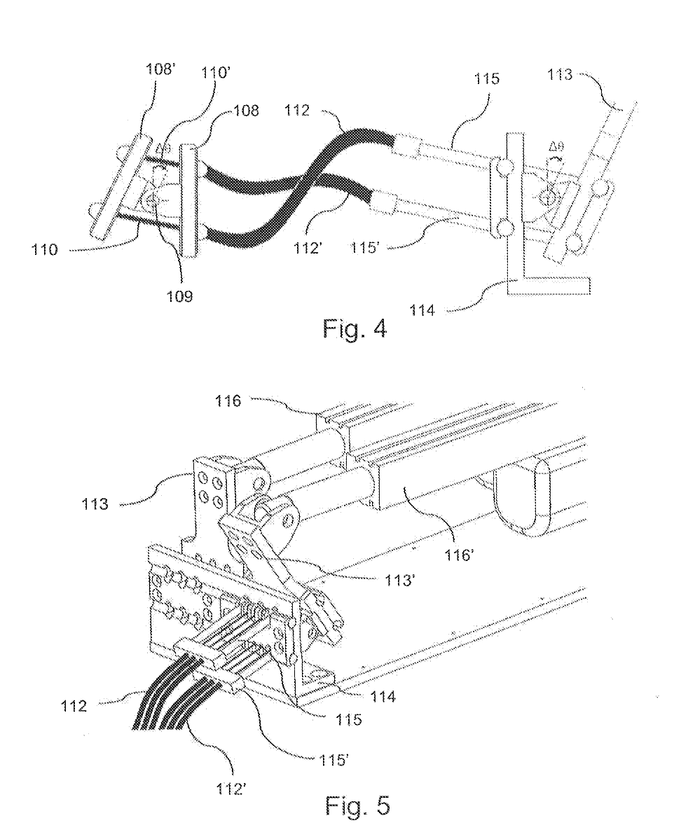

The actuation of such a structure does, however, present a series of specific problems. With reference to FIG. 3d it will be noted that, for a rotation of the hinge 109 through an angle Δθ, the reduction in length ΔL₁ of the portion of cable 110 between the rings 108 and 108′ is greater than the corresponding elongation ΔL₂ of the cable 110′. The two elongations ΔL₁ and ΔL₂ change in a non-linear fashion as a function of the angle of rotation Δθ. The movements to be applied to the two cables 110, 110′ change in a ratio that is not constant. Now, it is important that, in a pair of corresponding cables 110, 110′, the two cables be permanently under tension. The number of mechanical cables for controlling the two degrees of freedom of a mover is four. For the three successive identical movers, there will therefore be a total of twelve cables or sheaths to be run along inside the structure and to be actuated. One technical solution might be to provide an actuator for each of the cables, said actuator being controlled in accordance with a law that observes the aforementioned constraints. This solution would, however, require, a great many actuators, which would be detrimental to the portability and cost of the device. To avoid that, the applicant has designed an inverse control mechanism depicted schematically in FIG. 4. In this mechanism a control lever 113 and a fixed frame 114 are articulated by hinges in order faithfully to reproduce the layout of the two rings 108, 108′ and hinges 109, 109′ that are to be controlled. The dimensions are the same there as. Rigid linkages 115, 115′ are fixed to the control lever 113 and pass slideably through the fixed frame 114. The ends of the linkages 115 and 115′ are fixed to the proximal ends of the sheaths of the cables 112 and 112′,The proximal ends of the cables 110, 110′ are fixed to the frame 114, near the points where the linkages 115 and 115′ pass through the frame 114. The sheaths 112, 112′ are crossed as indicated in FIG. 4. Because the length of the cable 110 depicted in broken line in the figure is fixed, and equal to the length of the sheath 112 and of the linkage 115, depicted in dotted line, it will be appreciated that when the control lever 113 rotates by Δθ. the elongation of the portion of linkage between the control level 113 and the fixed frame 114 is equal to the elongation of the portion of cable 110 between the rings 108 and 108′. The same is true mutatis mutandis of the cable 110′ and the linkage 115′. This mechanism therefore provides control that observes the constraint of there always having to be tension in the two cables 110 and 110′ by using a single control member 113.

in order to actuate the three successive movers of the multi-jointed structure, it might be possible simply to group together in three the cables that act in the same direction about the same axis A-A′ and B-B′ on two control levers 113 and 113′ as depicted in FIG. 5. These two control levers 113 and 113′ can then be controlled each in turn by two electric, pneumatic or hydraulic actuators 116 and 116′. With this arrangement, one and the same angle of rotation is imparted to each of the three successive movers of the structure. The structure therefore adopts a constant curvature determined by the position of the actuators 116 and 116′.

With reference to FIG. 2, the distal end of the shoulder module 105 ShouldeRO comprises an arm shell 120 which may be fixed to the distal end of the patient's arm, above the elbow, by a prismatic connection (slideway) 121 and a cardan joint 122 capable of accommodating the variation in position and angle of the distal end of the shoulder module 105 according to the positions of the patient's arm. The rail 123 of the slideway 121 may be fixed to the shell 120 by screws or bolts, although because the degree of freedom in translational movement in the direction indicated by the arrow A is not subjected to any load during operation, attachment may advantageously be performed by one of the easy modes of assembly described hereinafter involving two male pieces secured to the rail and two female pieces secured to the shell 120, engaging in one another in the direction of the arrow A or in the opposite direction.

Arranged at the distal end of the structure is a test body 130 to which two measurement bridges consisting of extensometer gauges are applied. The signals transmitted make it possible to determine the force along the y-axis (Fy) and the force along the z-axis (Fz). Knowing the geometric model of robot, the torques at the joints can be deduced from this. These signals are transmitted to a controller which commands and controls the rehabilitation process. The shoulder module described makes it possible to obtain angles of rotation of the multi-jointed structure of +105° to −105 in the two directions of space, while applying a torque of 50 Nm.

### The Arm Module: ROThum

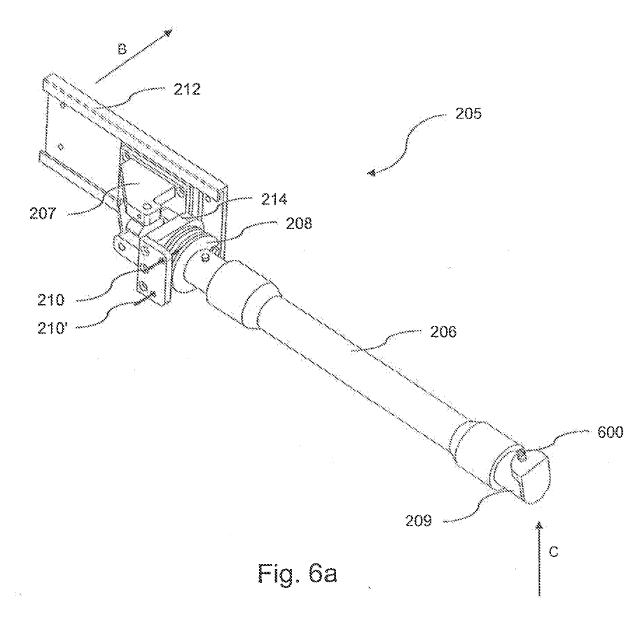

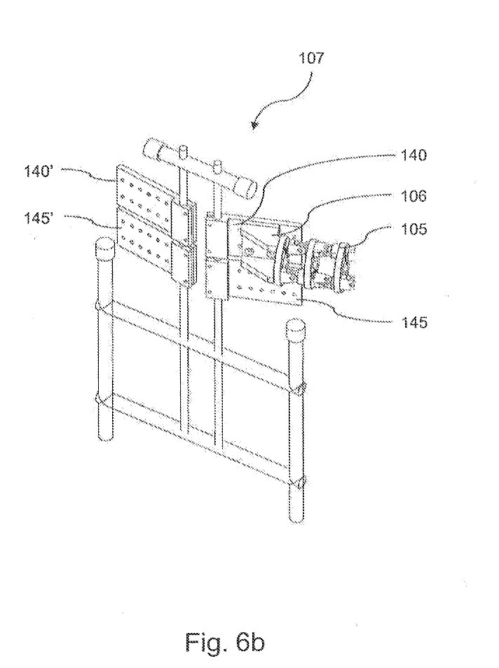

With reference to FIG. 6a, the humeral rotation module, hereinafter known as the “arm module” ROThum 205 allows the internal/external rotation movement of the arm also known as the humeral rotation. The mechanical structure comprises a flexible shaft 206. A flexible shaft is a transmission shaft capable of transmitting a torque while at the same time having flexibility that allows its two ends to operate in orientations that are misaligned and/or that are offset and allows it to adopt a planar or complex curvature. A flexible shaft usually comprises a helical spring, In order to be able to transmit torque in both directions of rotation of the shaft, it also comprises a second helical spring, concentric to the first, but of opposite hand. Finally, a sheath that can slide freely with respect to the springs protects the set and its environment. The arm module 205 comprises a base 207 in which the shaft is held with a degree of freedom in rotation. This base 207 can slide in a slideway 212. The slideway 212 may be secured to a dorsal holding device by screws or bolts. However, because the degree of freedom in translation in the direction indicated by the arrow B is not subjected to any load during operation, attachment may advantageously be performed using one of the easy methods of assembly described hereinafter, comprising two male pieces secured to the slideway 212, and two female pieces secured to the dorsal holding device 107. A pulley 208 is mounted on the proximal end of the shaft 206. Cables 210 and 210′ running through sheaths acting on this pulley 208 cause the distal end 209 of the flexible shaft 206 to rotate in both directions. The cables may be controlled by an electric motor installed in the fixed frame 114.

The flexible shaft 206 is placed along the lower part of the patient's arm. The distal end of the shaft is fixed either to the elbow module elBOT or to an elbow shell CC, which encompasses a portion of a patient's arm and forearm, by means of one of the easy modes of assembly described hereinafter, comprising a male piece 215 secured to the end of the flexible shaft and a female piece secured to the elbow module elBOT or to the elbow shell CC. Assembly is achieved by engagement in the direction of the arrow C, which is not subject to a load during operation. Adaptability to suit patients of different build is guaranteed by the linear-guidance slideway 212 which provides positional adjustment of the anchor point for the proximal end of the shaft 206 by sliding of the drive block 214 in the sideway 212. This slideway as an alternative could also be fitted to the distal end of the shaft 206. As the shaft 206 rotates under the impetus provided by the electric motor, a humeral rotation is imposed on the patient's arm. In this rotation, the shaft may, because of its flexibility, follow the line of the patient's arm. The slideway 212 provides the necessary lengthwise adjustment, when a rotation is being applied to a given patient and for the purpose of adapting to suit patients of different sizes.

The arm module 205 makes it possible to measure and transmit the torque and the angle of humeral rotation. The torque measurement can be obtained either by measuring the current flowing through the motor or by placing a measurement bridge made up of extensometer gauges directly on the flexible shaft in order to measure the torque transmitted by the flexible shaft or on a test body produced in the support of the drive block 214 in order to measure the reactive torque. The angular position of the arm is measured directly using an incremental encoder with which the motor is fitted.

The arm module 205 makes it possible to obtain angles of rotation of 95° for internal rotation and of 90° for external rotation and to do so providing a torque of 26 Nm, The use of a flexible shaft, particularly combined with a slideway, makes it possible to achieve segmental rotation in an exoskeleton while at the same time complying with constraints on weight, bulk and adaptability to suit the build of the patient.

Both the shoulder module 105 and the arm module 205 can be anchored to the patient's torso by means of a dorsal holding device 107 depicted in FIG. 6b which is worn like a rucksack and can be tightened around the waist. Straps, not depicted in FIG. 6b, are used for tightening around the waist and the dorsal support. Plates 140 and 140′ provide attachment for the base 106 of the shoulder module 105, both for the right arm and for the left arm of the patient. Likewise, plates 145 and 145′ allow attachment for the slideway 212 of the arm module 205.

### The Elbow Module: elBOT

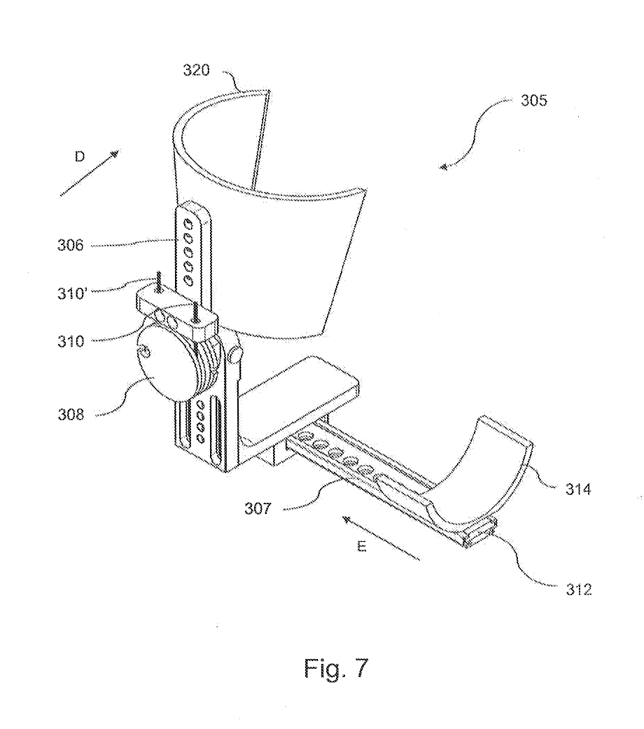

The module that flexes and extends the elbow, hereinafter known as the “elbow module” elBOT 305 is depicted in FIG. 7. The pivot connection comprises an upper part 306, which may be attached by a shell 320 to the distal part of the patient's arm, and which is articulated to a lower part 307 which may be attached by a shell 314 to the proximal part of the patient's forearm. The shells 320 and 314 may be attached almost permanently by screws or bolts to the upper 306 and lower 307 parts respectively. However, because the degree of translational movement in the direction indicated by the arrow D is not subject to any load during operation, attachment may advantageously be performed by one of the easy modes of assembly described hereinafter, comprising two male pieces secured to the upper part 306 and two female pieces secured to the shell 320. Likewise, the degree of freedom in translational movement in the direction indicated by the arrow E is not subjected to any load in operation so the attachment may advantageously be performed by one of the easy modes of assembly described hereinafter, comprising a male piece secured to the slideway 312 oriented in the direction of the arrow E or in the opposite direction, and a female piece secured to the shell 314.

A pulley 308, secured to the lower part 307, is turned by an offset electric motor, driven by cables 310 and 310′ running through sheaths. A slideway 312, positioned between the lower part 307 of the elbow module 305 elBOT and the shell 314 attached to the proximal part of the patient's forearm, is able to absorb any misalignment between the axis of the pivot connection of the elbow module and the axis of the patient's elbow joint.

The elbow module makes it possible to measure and transmit the torque and angular position. The torque is obtained by a force sensor consisting of extensometer gauges positioned in a half bridge arrangement under the slideway rail. The angular position is measured using an incremental encoder with which the motor is fitted. The elbow module allows the transverse elbow joint to be made to undergo flexing/extending movements over an amplitude of 145°, and with a torque of 30 Nm.

### Ulnar Rotation: ROTuln

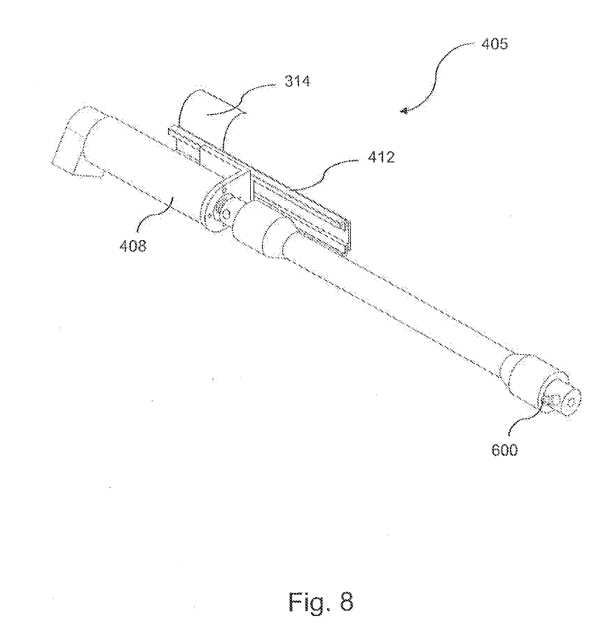

The ulnar rotation module that allows pronation and supination, hereinafter termed the “forearm module” ROTuln 405 depicted in FIG. 8 allows the forearm to be made to undergo the pronosupination movement, also known as the ulnar rotation. The mechanical structure of this module is made up, like the arm module, of a flexible shaft 406 able to transmit torsion forces in both directions. This shaft is positioned along the forearm and is actuated by a direct-drive electric motor 408. Actuation could, however, be offset via a mechanical cable transmission, like for the arm module, or alternatively, using another flexible shaft. The forearm module 405 used alone is fixed at its proximal end to an elbow shall CC or to a shell 314 placed on the proximal end of the patients forearm, and at its distal end to a shell 514 (not depicted) fixed to the patient's hand. It may also be assembled with the shell 314 of the elBOT module or with the upper part 506 of the pivot connection of the wrist module wristlC.

The modes of assembly by means of easy fastenings of the ROTuln module are, in all respects, similar to those described for the ROThum module. A slideway 412 positioned between the proximal end of the flexible shaft 406 and the elbow shell CC or the shell 314 placed on the proximal end of the patient's forearm allows the length of the forearm module to be adapted to suit the build of the patients, and to adapt during rotation.

The forearm module makes it possible to measure and transmit the segmental torque and angular position. As far as torque measurement is concerned, this can be achieved either by measuring the current flowing through the motor or by positioning a measurement bridge made up of extensometer gauges directly on the flexible shaft in order to measure the torque transmitted by the flexible shaft or on a test body produced in the support of the drive block in order to measure the reactive torque. The measurement of the angular position of the arm is obtained directly by means of an incremental encoder with which the motor is fitted.

The maximal amplitudes achieved are as much as 85° for pronation and 90° for supination, and this with a torque of 5 Nm.

### Wrist Module: wristlC

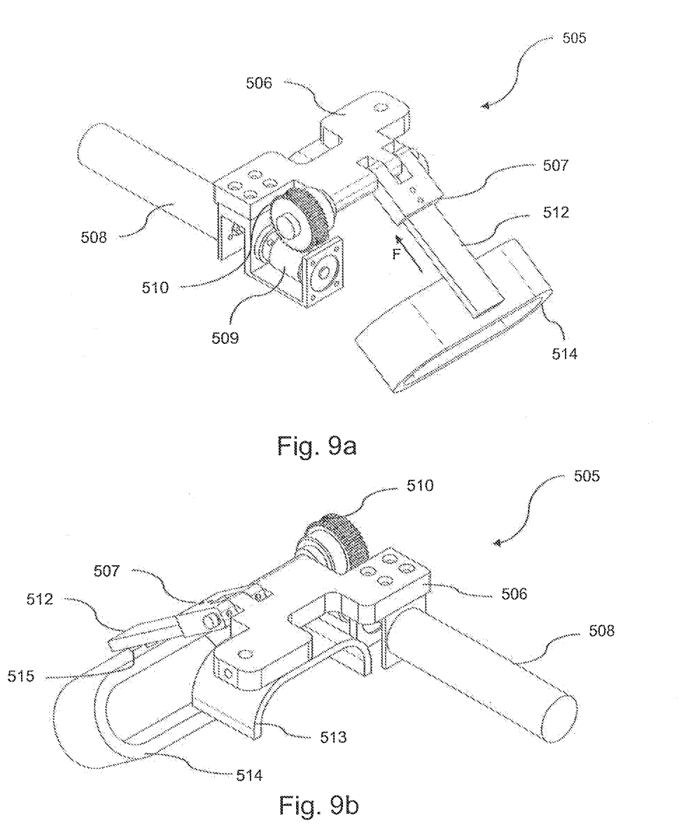

The wrist module wristlC 505 is depicted in FIGS. 9a and 9b. The pivot connection of this module comprises an upper part 506 which comprises a shell 513 which can be fixed to the distal end of the patients forearm. This shell 513 is fixed by bolting.

The upper part 506 is articulated to a lower part 507 which comprises a slideway 512 which may be attached to a hand shell CM 514 attached to the patient's hand.
The hand she 514 may be attached to the slideway 512.
However, because the degree of freedom in the direction of the arrow F is not subjected to any load, assembly can be achieved using a male piece secured to the slideway 512 engaging in a female piece secured to the shell 514, in the direction of this arrow or in the opposition direction.

An electric motor 508, secured to the upper part 506, drives an endless screw 509, itself driving a gearwheel 510 secured to the lower part 507. The axis of the pivot connection is superposed with the axis of the transverse joint of the wrist. Because the lever arm there is between the biomechanical joint and the wrist module 505 wristlC, there needs to be a translational movement and a rotational movement, both passive, in order to be able to guarantee angular movement between the hand and forearm. This is why a slideway 512 fitted with a hinged carriage 515 is inserted in the second part of the hinge. The shell 513 is attached to the external face of the distal part of the patients forearm using a system of straps with touch-and-close (Velcro®) fastenings.

The wrist module is able to measure and transmit joint torque and position. As far as torque measurement is concerned, this is obtained by use of a force sensor consisting of extensometer gauges positioned in a half bridge configuration on the rail 507 of the slideway 512 positioned on the proximal part of the hand. The measurement of the angular position of the wrist is obtained directly by means of an incremental encoder with which the motor is fitted, The wrist module allows the transverse joint of the wrist to be made to undergo flexion/extension movements over an amplitude of 145° and to do so at a torque of 3 Nm.

### Modules Used Jointly

The five modules described hereinabove can be used in isolation or jointly, in all possible combinations.

In each of these combinations, the shoulder module 105 ShouldeRO is attached at its proximal end to the dorsal holding device 107 and at its distal end to the shell 120 on the distal part of the patient's arm, Use of this module is therefore independent. As an alternative, the shoulder module can be assembled with the elbow module or with an elbow shell CC, if no arm module is being used. However, in such a case, the internal/external rotation movement of the arm is not possible.

In each of these combinations also, the arm module 205 ROThum is always fixed at its proximal end to the dorsal holding device 107 whereas at its distal end:
when it is used with the elbow module 305 elBOT, it is attached to the latter;
when it is used with the forearm module 405 ROTuln without the elbow module 305 elBOT, it is attached to an elbow shell (CC) which encompasses the entire elbow.
   Outside of that, its use is independent.

The elbow module 305 elBOT is fitted, at its proximal end, to:

6 the attachment for the shoulder module 105 ShouldeRO if used with the shoulder module 105 ShouldeRO without the arm module 205 ROThum;
the attachment of the arm module 205 ROThum if used with the arm module 205 ROThum with or without the shoulder module 105 ShouldeRO;
otherwise its use is independent.
   Whereas at its distal end it is attached to:
the attachment for the forearm module 505 ROTuln, if used therewith;
otherwise its use is independent.

The forearm module 405 ROTuln is fixed at its proximal end:
if used with the elbow module 305 elBOT, it is fixed to the latter;
if not, its use is independent.
   Whereas at its distal end:
if used with the wrist module 505 wristlC, it is attached to the latter,
if not, its use is independent.

The wrist module 505 wristlC is attached at its proximal end;
to the attachment for ROTuln, if used therewith;
otherwise its use is independent.
   A number of preferred combinations are described hereinafter.

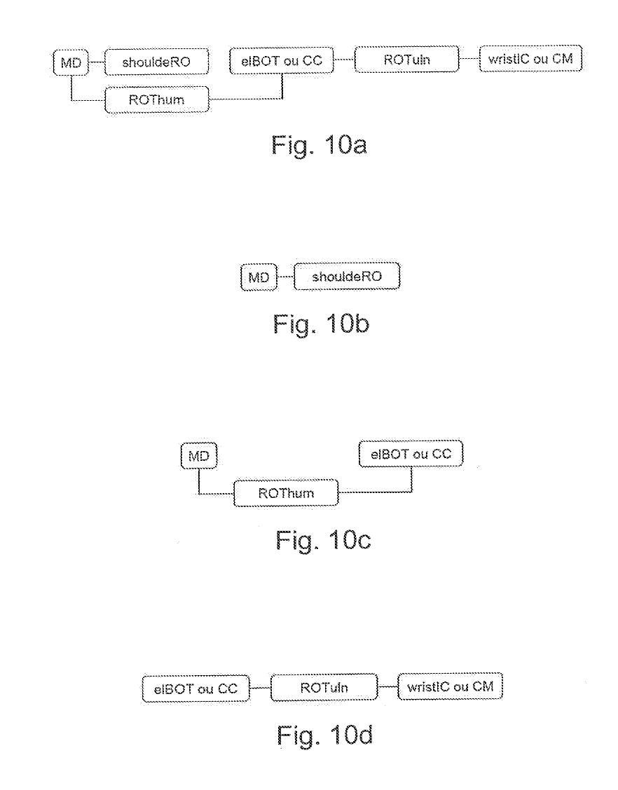

FIG. 10a schematically depicts the layout of the five modules used jointly. The shoulder module 105 ShouldeRO is attached to the arm shell 120. Alternative versions in which the module elBOT is replaced by an elbow shell CC and/or the wrist module wristlC is replaced by a hand shell CM are also depicted. Adjacent modules are connected by a line.

FIG. 10b schematically depicts the use of the module shouldRO in isolation.

FIG. 10c schematically depicts the use of the module ROThum in combination with the module elBOT or the elbow shell CC.

FIG. 10d schematically depicts the use of the module elBOT or of the elbow shell CC in combination with the module wristlC or the hand shell CM. This combination can be used for example in a final stage of rehabilitation when only the forearm and wrist need to be exercised,

### Methods of Assembling the Modules and Shells

As explained hereinabove, certain assemblies do not need to be subjected to any forces in the 6 degrees of freedom. In addition, the shells or other supports, such as the dorsal support module, to which they are attached, are not specific to these modules. It is therefore possible and advantageous to use an attachment device that allows the modules and attachment accessories to be secured together or detached. Specifically, in almost all instances, there remains, at the attachment, at least one degree of freedom in translational movement which does not react any load during operation. This degree of freedom is then used for engaging or disengaging, by hand, an attachment that immobilizes all or some of the remaining 5 degrees of freedom. In order to avoid it becoming disengaged as a result of the movements performed during the exercises or under the effect of gravity, this attachment, at the end of its travel and in the degree of freedom of engagement, has an automatic locking system that can be enabled and disabled through modest human effort. Blocking of the degrees of freedom that are to transmit force may be obtained by cutting, in each of the two pieces that constitute the attachment, two identical volumes which are defined by the extrusion of some surface in the direction corresponding to the degree of freedom of engagement of the attachment, one of these volumes being positive and defining the male part of the attachment and the other being negative and defining the female part of the attachment. If the extrusion surface is circular, the attachment does not constrain/leaves free the degree of freedom in rotation about the axis of the cylinder thus formed. In all other cases, the method of assembly blocks all of the 5 degrees of freedom, something which is necessary, for example, for the attachment of the proximal end of the module ROThum.

For all the attachments, except for the proximal attachment of the ROThum module, an embodiment based on a circular extrusion surface is preferred, not only because the axes and the holes resulting from the extrusion can be obtained very easily using conventional manufacturing means, but also because leaving 1 degree of freedom unconstrained in rotation will make it easier to engage the male part of the attachment in the female part.
In the case of the proximal attachment of the ROThum module, which entails blocking 5 degrees of freedom, an extrusion surface formed of two or more circles is produced so that it can be produced using simple axes and holes, like the previous attachment.
In all cases, it is advantageous for the end of the male part and the entrance to the female part to be profiled in such a way as to make it easier for the one to engage in the other.

The locking of the attachment may be obtained by active means (pneumatic, hydraulic, electrical, thermal, etc. means) or passive means (mechanical, magnetic, etc. means). Given the forces that the attachment is to withstand in its direction of engagement, it is entirely possible just to have passive means that require no action other than the application of sufficient force in the direction of engagement.

Among the various possible methods of assembly, three preferred embodiments are described hereinafter.

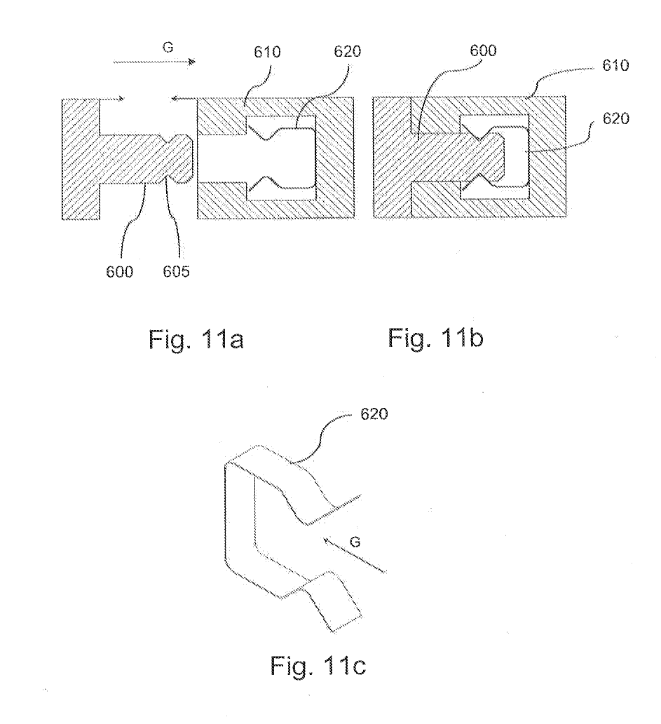

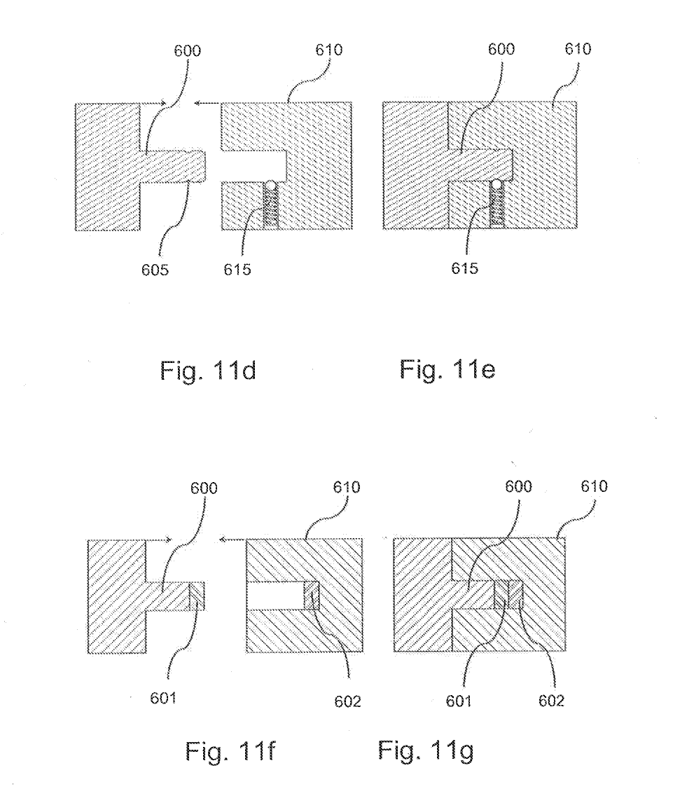

The first method of assembly, depicted in FIGS. 11a, 11b and 11c, uses a spring clip system. The male piece 600 is engaged in a direction depicted by the arrow G in an opening in the female piece 610. The spring dip 620 is a piece made of high elastic limit steel sheet shaped so as to be able to engage, by undergoing elastic deformation, on the male piece 600 and to hold the latter in position by damping. Mounted inside the female piece 620, this dip system may serve to block the piece by means of a notch 605 of the male piece 600 adapted to the profile of the spring clip 620. The precise shape given to the profile of the male piece 600 and the stiffness and profile of the spring clip 620 determine the force needed for enabling and disabling the blocking system.

The second mode of assembly depicted in FIGS. 11d and 11e uses a spring-loaded push-button system 615. The spring-loaded push-button 615 is a mechanical component comprising a ball loaded by a spring. The assembly thus formed is generally placed in a chamber of cylindrical shape intended to keep the ball in abutment and the spring under load. This system, through the ball, is able to apply a force to another piece while at the same time tolerating a certain movement of the ball along the axis of the spring. The desired blocking effect here can be obtained by housing the spring-loaded push-button in the opening of the female piece 610 of the attachment, at right angles to the direction of engagement depicted by the arrow G, and by correctly shaping the male piece 600 in order first of all to allow the ball to be first of all pushed back against the action of the spring then released into a notch 605, The exact shape given to the profile of the male piece 600 and the stiffness and level of preload of the spring determine the force needed to enable and disable this blocking system.

The third mode of assembly depicted in FIGS. 11f and 11g uses permanent magnets. The permanent magnets have the ability to apply a force of attraction to ferromagnetic pieces. This force has the specific feature of being stronger the closer together the ferromagnetic piece and the magnet. By making the male part of the attachment, or at least the end thereof, from a ferromagnetic material 601 and by placing opposite it a permanent magnet 602 which is attached to the female part, a holding force will be obtained once the attachment is fully engaged. Conversely, the magnet 602 may be attached to the end of the male part 600 and the ferromagnetic material 601 may be arranged in the female part. The size and shape given to the ferromagnetic component 601 and to the permanent magnet 602, as well as the magnetic properties of these materials, will determine the force necessary for disabling the blocking system.

A module may comprise several female pieces or openings 610, arranged in various positions, so as to provide freedom of choice of layout. For example, the upper part 306 of the elBOT module comprises several openings 610, as do the plates 140, 145 of the dorsal holding module,

The combination of a blocking device and of a locking device, like those described hereinabove, therefore makes it possible to obtain quick-fix systems (so-called because they can be engaged and disengaged without tools, simply using a force in the direction of engagement of the attachment) capable of transmitting the forces required by the two modules ROThum and ROTuln, both at the proximal level and at the distal level.

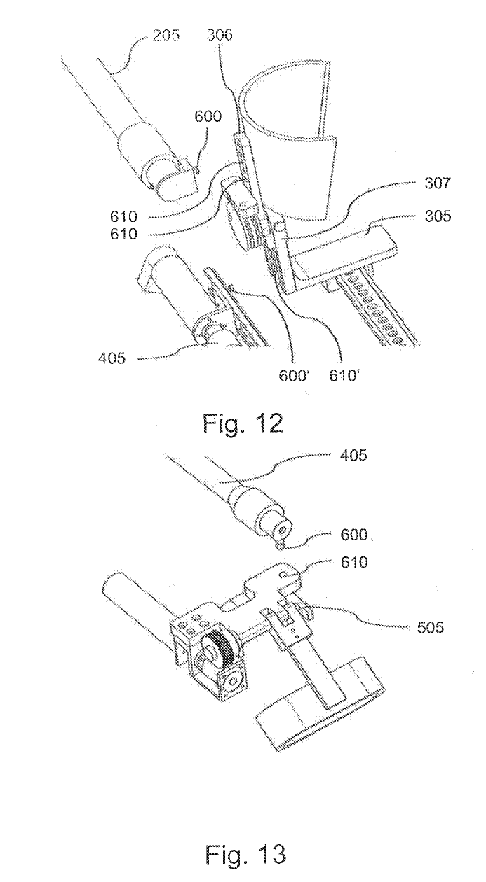

In practice, part of the attachment will be secured to one end of a module while the other part will be secured to the support to which the end of the module is to be attached. The choices to be able to position the male part of the attachment on the module and the female part on the support or vice versa is left open. Depending on the module ROThum and ROTuln, and the other modules used in combination therewith, this support may be a simple elbow shell or wrist shell, the dorsal harness or alternatively one of the elBOT and wristlC modules. The way in which the male and female parts of the attachment are secured to the modules and the supports is left free. It may, but does not have to be, permanent. The way in which the male and female parts of the attachment are oriented on the modules and the supports is important because the degree of freedom of engagement must not correspond with one of the degrees of freedom in which a force is to be transmitted. On this point, FIGS. 12 and 13 comply with this constraint. Were this condition not to be met, there would be a possibility of the attachment becoming disengaged during operation.

FIG. 12 depicts the way of joining the arm module 205 and the forearm module 305 to the elbow module 205. The male piece 600 of the arm module 205 can fit into one of the female pieces or openings 610 made in the upper part 306 of the elbow module elBOT. The male piece 600′ of the forearm module ROTuln 405 can fit into one of the openings 610′ made in the lower part 307 of the elbow module elBOT.

FIG. 13 depicts the way of joining the forearm module 405 to the wrist module 505 wristlC. The male piece 600 of the forearm module ROTuln 405 can fit into the opening 610 made in the upper part 506 of the wrist module wristlC 505. The shoulder module ShouldeRO 105 may also be fitted with a male piece 600 to join it to the elbow module 305.

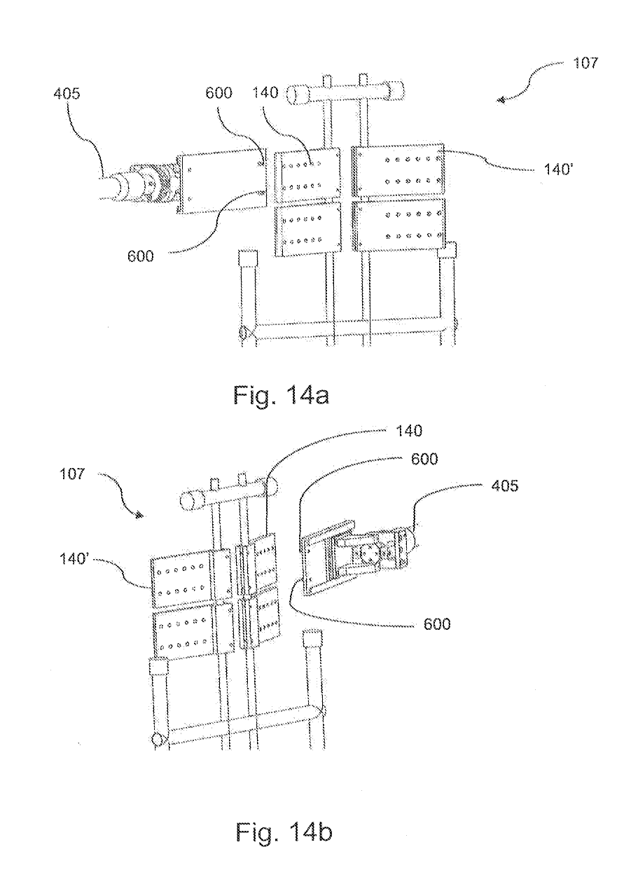

FIGS. 14a and 14b respectively depict a front view and a rear view of the assembly of an arm module with the dorsal module. As explained hereinabove, this assembly entails the blocking of 5 degrees of freedom. Two male pieces 600, 600′ are inserted in a pair of openings 610, 610′ made in a plate 140 of the dorsal module.

The plate 630 may advantageously have a plurality of holes 610, 610′ allowing a suitable choice to suit the size of the user.

The robotized device according to the invention is intended to help hemiplegic patients in their rehabilitation process by allowing them, autonomously, to carry out rehabilitation exercises on their upper limbs. The modular approach of the device of the invention offers numerous advantages. Chief among these is that it leaves the therapist free to choose those articulations which require robotized assistance and to do so according to the progress the patient is making in their rehabilitation and according to the type of exercise to be performed. Moreover, the device of the invention has greater morphological adaptability thanks to:
the modular aspect of the exoskeleton in which each module is attached around a particular joint independently of the rest of the limb;
the biomechanical approach of the various modules in which the idea is not to reproduce the patient's joint per se but rather to lean on it, generating loads on those parts of the limb that are connected to it.
   Thanks to the modular nature, it is possible for the module or modules needed for the intended rehabilitation to be used. This then reduces the weight that the patient has to bear during rehabilitation if the rehabilitation requires just one or a few modules. The method of assembling the modules and the shells or other accessories allows for quick and easy assembly/dismantling, without the need to resort to tools.

The mechanical design of the modules of the invention makes it possible to obtain modules of a weight that is acceptable to the patient.

The terms and descriptions used here are proposed merely by way of illustration and do not imply any limitation. A person skilled in the art will recognize that numerous variations are possible within the spirit and scope of the invention as described in the claims which follow and equivalents thereof. In these claims, all the terms are to be understood in their broadest possible meaning unless indicated otherwise. In particular, measurements of loads (torques and forces) and position which are described for each of the modules are not limited to those set out here. The layout of male pieces on one module and of female pieces on another module may be reversed.

1. A device for mobilizing and rehabilitating an upper limb of a patient, wherein the device is constructed by assembling at least two adjacent elements chosen from a set consisting of a shoulder module (105) (ShouldeRO), an arm module (205) (ROThum), an elbow module (305) (elBOT), a forearm module (405) (ROTuln), a wrist module (505) (wristlC), a dorsal holding device (107), an elbow shell CC and a hand shell (514), wherein each of the elements (105; 205; 305; 405; 505; 107; CC; 514) of the set being designed to be secured to at least one other adjacent element (105; 205; 305; 405; 505; 107; CC; 514) of the set, at least one assembly of a first element with a second element being achievable by engaging a male piece (600) secured to the first element into an opening in a female piece (610) secured to the second element in a direction of engagement which is not subjected to any load when the device is in operation, and by locking said male piece (600) in said female piece (610) using means that can be unlocked under the effect of a pull in a direction opposite to said direction of engagement.

2. The device as claimed in claim 1, wherein, in said unlockable means, said male piece (600) comprises a notch and said female piece (600) is provided with a spring clip (620) so that upon assembly, the spring clip (620) engages in the notch, the male piece (600) thus being held in position but being able to be released by said pull.

3. The device as claimed in claim 1, wherein, in said unlockable means, said male piece (600) comprises a milled groove (605) and said opening is provided with a spring-loaded push-button (615), so that upon assembly, the ball of the spring-loaded push-button (615) engages in the milled groove (605), the male piece (600) thus being held in position but being able to be released by said pull.

4. The device as claimed in claim 1, wherein, in said unlockable means, said male piece (600) comprises at its end a ferromagnetic material and the closed end of said opening is provided with a magnet so that the male piece (600) is thus held in place but can be released by said pull.

5. The device as claimed in claim 1, wherein said shoulder module (105) (ShouldeRO) comprises a multi-jointed structure comprising a succession of rings (108, 108′) articulated to one another by hinges (109, 109′, 109″, 109″′).

6. The device as claimed in claim 5, wherein the multi-jointed structure comprises mechanical cables (110) running through sheaths, a pair of cables (110, 110′) controlling the rotation of a ring (108′) with respect to the ring (108) that precedes it in the succession of rings (108, 108′).

7. The device as claimed in claim 1, wherein said arm module (205) (ROThum) comprises a flexible shaft (206), the proximal end of the shaft (206) being made to rotate and allowing the rotation to be imparted to the distal end of said shaft.

8. The device as claimed in claim 7, wherein a slideway (212) is arranged at one of the ends of the flexible shaft (206) so that the length of the arm module (205) can be adapted to suit the position and build of a patient.

9. The device as claimed in claim 1, wherein said elbow module (305) (elBOT) comprises a pivot connection comprising an upper part (306) and a lower part (307), the lower part (307) comprising a slideway (312) supporting a shell (314) that can be fixed to the proximal part of the forearm of a patient.

10. The device as claimed in claim 1, wherein said forearm module (405) (ROTuln) comprises a flexible shaft (406), the proximal end of the flexible shaft (406) being made to rotate and allowing a rotation to be imparted to the distal end of said shaft.

11. The device as claimed in claim 10, wherein a slideway (412) is arranged at one of the ends of the flexible shaft (406) so that the length of the forearm module (405) can be adapted to suit the position and build of a patient.

12. The device as claimed in claim 1, wherein said wrist module (505) (wristlC) comprises a pivot connection comprising an upper part (506) and a lower part (507), the lower part comprising a slideway (512) supporting a hand shell (514) that can be fixed to the hand of a patient.

13. A method of assembling a device for mobilizing and rehabilitating an upper limb of a patient, comprising the step of assembling at least two elements chosen from the set consisting of a shoulder module (105) (ShouldeRO), a humeral rotation module (205) (ROThum), an elbow module (305) (elBOT), a forearm module (405) (ROTuln), a wrist module (505) (wristlC), a dorsal holding device (107), an elbow shell CC and a hand shell (514), each of the elements (105; 205; 305; 405; 505; 107; CC; 514) of the set being designed to be secured to at least one other adjacent element (105; 205; 305; 405; 505; 107; CC; 514) of the set, at least one assembly of a first element with a second element being achievable by engaging a male piece (600) secured to the first element into an opening in a female piece (610) secured to the second element in a direction of engagement which is not subjected to any load when the device is in operation, and by locking said male piece (600) into an opening in said female piece (610) using means that can be unlocked under the effect of a pull in a direction opposite to said direction of engagement.

14. The method as claimed in claim 13, wherein said assembling step is performed by engaging said male piece (600) comprising a notch into said opening of the female piece (610) equipped with a spring clip (620), so that the spring clip (620) engages in the notch, the male piece (600) thus being held in place but being able to be released by said pull.

15. The method as claimed in claims 13, wherein said assembly is performed by engaging said male piece (600) comprising a milled groove (605) into an opening in said female piece (610) equipped with a spring-loaded push-button (615), so that the ball of the spring-loaded push-button (615) engages in the milled groove (605), the male piece (600) thus being held in place but being able to be released by said pull.

16. The method as claimed in claim 13, wherein said assembly is performed by engaging said male piece (600) comprising a ferromagnetic material at its end, in an opening of said female piece, the closed end of said opening being equipped with a magnet, so that the male piece (600) is thus held in position but can be released by pulling.
